(19) United States
(12) Patent Application Publication
(10) Pub. No.: US 2019/0316393 A1
(43) Pub. Date: Oct. 17, 2019

(54) CONTROLLING APPARATUS AND METHOD FOR VEHICLE DOORS

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW); Tianle Chen, Shanghai City (CN)

(21) Appl. No.: 15/981,862

(22) Filed: May 16, 2018

(30) Foreign Application Priority Data
Apr. 17, 2018 (CN) 201810345375.X
Apr. 17, 2018 (CN) 201820545153.8

(51) Int. Cl. E05C 17/00; E05F 15/42

(52) U.S. Cl. CPC E05C 17/006; E05F 15/611; E05F 15/42

(57) ABSTRACT

A controlling apparatus for vehicle doors, which control is based on the surrounding circumstances of the vehicle. The controlling apparatus includes: a sensing module sensing at least one object surrounding the vehicle and collecting information thereof; a processing unit connected to the sensing module, the processing unit receiving and analyzing the information to determine if a warming flag should be issued based on the status of the object, and a programmable damper module connected to the processing unit and imposing a resistance on the vehicle doors based on the warming flag to control the opening of the vehicle doors.

### BACKGROUND OF THE INVENTION

### 1. Field of the Invention

The present invention relates to a controlling apparatus and a control method thereof for vehicle doors, and particularly to a controlling apparatus and a method thereof based on statuses of objects surrounding the vehicle.

### 2. Description of the Prior Art

As the number of vehicle increases, the public is aware of issues regarding safe driving in daily lives. Because of the concern, consumers are willing to pay more for vehicles equipped with safety facilities. These proactive safety facilities not only enhance the safety of vehicle itself, but also prevent passengers, pedestrians, as well as moving vehicles/objects from being harmed because of traffic accidents. More frequently, a driver may park the car aside and get off to run errands. If either the driver or the passenger rushes to open the vehicle door without looking out the surrounding situation, a tragedy may happen. Sometimes it is the sudden open of the vehicle door that hits a pedestrian or a person riding bicycle/motorcycle approaching the vehicle; or sometimes it is the driver/passenger getting off the vehicle who is struck by a coming vehicle. These sorts of injuries could be fatal but usually avoidable if more careful attention is paying to.

Under the conventional design of vehicle, the passengers can casually unlock the door and get off the car without the driver's intervene. Despite there are rearview and side mirrors helping the driver (rather than the passengers) to judge if it will be safe to leave the car, it still relies on the driver's vigilance to actually look into these mirrors in advance. If the driver negligently forgets to take the precaution, accidents may just happen. Based on the foregoing reasons, there exists a need to proactively control the opening of vehicle doors for passengers and drivers in a much safer way.

### SUMMARY OF THE INVENTION

The present invention discloses a controlling apparatus and a method thereof for controlling the vehicle doors of a vehicle based on the status of the object(s) surrounding the vehicle.

One embodiment of the present invention discloses a controlling apparatus for controlling the opening of vehicle doors of a vehicle. The controlling apparatus includes: a sensing module configured to sense at least one object surrounding a vehicle and collect information related to the object; a processing unit configured to receive and analyze information of the object, and issue a warning flag based on a status of the object; and a programmable damper module connected to the processing unit and configured to impose a resistance on the vehicle door and thereby limits the vehicle door's open based on the warning flag.

Another embodiment of the present invention discloses a controlling apparatus for controlling the opening of vehicle doors of a vehicle. The vehicle has an open range within which the vehicle doors can be opened completely. The controlling apparatus includes: a sensing module arranged around the vehicle and configured to sense at least one moving object approaching the vehicle and collect information related to the moving object; a processing unit connected to the sensing module and configured to analyze the information of the moving object and determine whether to issue a warning flag by judging whether the moving object will be entering into the open range and if so the duration of time of the entrance; and a controlling module connected to the processing unit and configured to control the vehicle door's open based on the warning flag.

A further embodiment of the present invention discloses a controlling method for a vehicle. The method includes: sensing at least one moving object approaching the vehicle; collecting a distance between the moving object and the vehicle, and a velocity and a moving direction of the moving object; analyzing the distance, the velocity and the moving direction to determine a duration of time that the moving object will be entering into an open range of the vehicle, and issue a warning flag accordingly; and controlling the vehicle door based on the warning flag.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute apart of this specification. The drawings illustrate some of the embodiments and, together with the description, serve to explain their principles. In the drawings:

FIG. 1 illustrates a block diagram of a controlling apparatus for vehicle doors according to a preferred embodiment of the present invention;

FIG. 2 illustrates a flowchart of a method for controlling vehicle doors according to a preferred embodiment of the present invention; and

FIG. 3 illustrates a schematic diagram of moving objects approaching a vehicle according to a preferred embodiment of the present invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description of the invention, reference is made to the accompanying drawings which form a part thereof, and in which are shown specific embodiments in which the invention may be practiced byway of illustration. These embodiments are described in sufficient details to allow those skilled in the art to practice the invention. It should be noted that all the figures are diagrammatic. Relative dimensions and proportions of parts of the drawings have been shown exaggerated or reduced in size, for the sake of clarity and convenience in the drawings. Other embodiments may be utilized and structural, logical, and electrical changes may be made without departing from the scope of the present invention. Accordingly, the following disclosure should not be construed as limited. Rather, the embodiments therein are only defined by the metes and bounds of the appended claims.

It should be noted that, certain words used in the specification and claims to refer to particular components. Those skilled in the art will be understood, the vehicle manufacturers may use different terms to refer to a component. The present specification and claims is not to distinguish the differences in terms of the assembly as a way to differentiate components but to function as a distinguishing criterion. As used throughout the specification and claims, reference to “comprising” or “comprises” is an open-ended fashion, and thus should be interpreted to mean “including, but not limited to.” Instructions subsequent description of preferred embodiments of the present invention embodiments, however the general principles described are based on the specification for the purpose, it is not intended to limit the scope of the present invention. The scope of protection of the present invention is defined by the following claims and their equivalents.

To provide a better understanding for the embodiments of present invention, several exemplary embodiments will be described in sufficient details with reference to the drawings. The drawings do not intend to limit the embodiments of the present invention

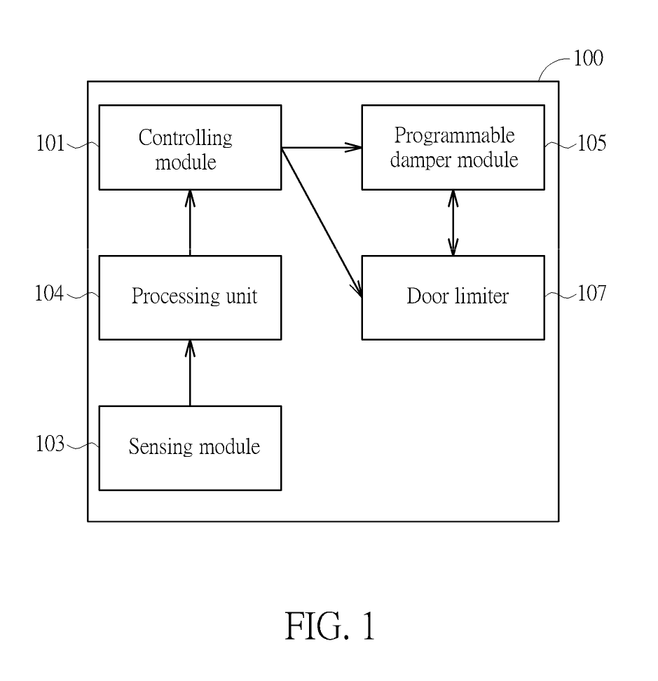

First, FIG. 1 illustrates a block diagram of a controlling apparatus 100 for vehicle doors according to a preferred embodiment of the present invention. As shown, the controlling apparatus 100 includes a sensing module 103, a processing unit 104, and a controlling module 101.

Please refer to FIG. 1. The sensing module 103 may be arranged around a vehicle A and connected to the processing unit 104. In the present invention, the sensing module 103 may be a computer vision-, a mechanical visual-, a radar- or lidar-type of sensor. For the mechanical visual-type sensor, the sensing module 103 maybe a camera collecting image frames surrounding the vehicle A during a time period. The image frames are sent to the processing unit 104 for further analyzing the objects in the image (such as pedestrians and other vehicles). For instance, distances among the vehicle A and moving objects, and velocities and moving directions of the moving objects may be obtained based on the relative positions of the vehicle A and the moving objects on the consecutive image frames. In the aspect of a radar-type sensor, such as ultra sound device, radar, etc., the sensor derives distances among objects, velocities, and moving directions by measuring frequency bounces. In another embodiment, the sensing module 103 may also obtain the above information by light metering. Regardless what kind of sensor is adopted, solely or in combination, the sensing module 103 of the present invention is used to collect information regarding the objects surrounding the vehicle A. The processing unit 104 then determines the distances among the objects and the vehicle A based on the obtained information to conclude their statuses (i.e. moving or stop), and further calculates the velocities of those moving objects and their prospective directions. Consequently, if any moving object is approaching toward the vehicle A, the duration of time it will take to get close to the vehicle A can also be obtained.

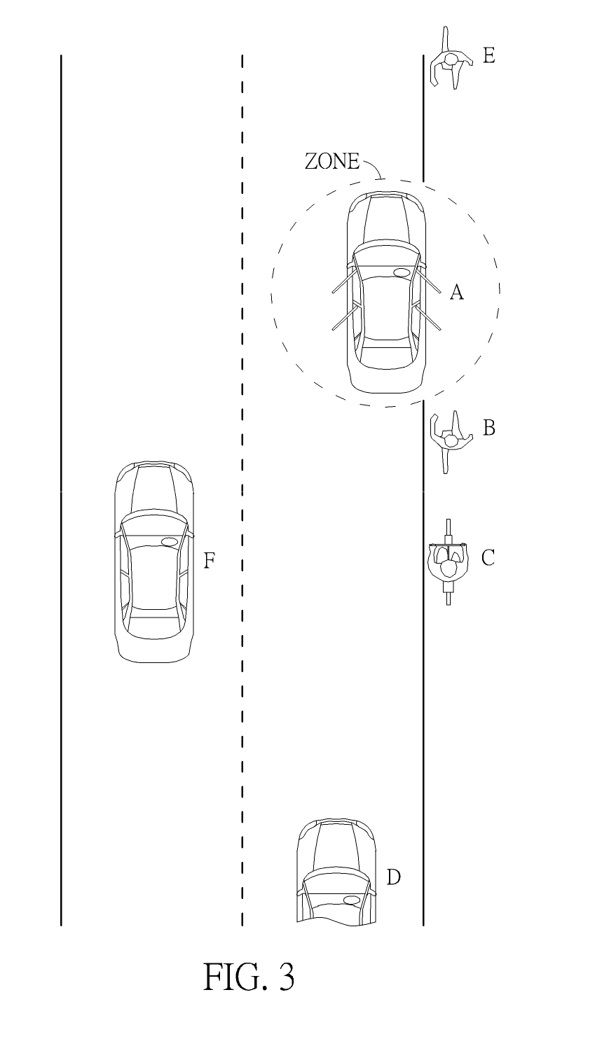

Besides, as shown in FIG. 3, the controlling apparatus 100 of the present invention may define an open range, i.e. Zone, within which the vehicle doors of the vehicle A can be opened completely. In one example, Zone may be equivalent to the width of a vehicle door measured when it is widely open plus a buffering distance.

Moreover, in the preferred embodiment of the present invention, the processing unit 104 may further calculate the duration of time that a moving object will take to enter into the Zone based on the collected information to decide whether to issue a warning flag. In addition, the warning flag may be of several levels, i.e. extreme/high/moderate/low/none danger. The other modules/hardware of the controlling apparatus 100 will subsequently act in accordance with the given level of the warning flag. Precisely, the warning flag is sent to the controlling module 101 which, based on the level of the warning flag, controls the other modules/hardware to perform correspondingly.

For example, as shown in FIG. 3, if the processing unit 104 calculates that the object B will be in the Zone in 0-2 seconds, the processing unit 104 then issues a warning flag with an extreme-danger level. If it is determined that the object C will enter into the Zone in 2-4 seconds, the processing unit 104 then issues a high-danger level of warning flag. Moreover, if it will take the object D 4-6 seconds to get close to vehicle A, the processing unit 104 will then issue a moderate-danger level of warning flag. If the processing unit 104 calculates that the duration of time that the object E will be entering the Zone is more than 6 seconds, the processing unit 104 may issue a warning flag with a low-danger level. The controlling module 101, based on the different levels of the warning flag, gives different commands to subsequent modules to control the vehicle doors. Additionally, if the processing unit 104 determines that the Object F will never enter Zone, the processing unit 104 will choose not to issue a warning flag at all. It should be noted that the aforementioned time periods are used for demonstration purposes only, thus they shall in no event constitute any limitations on the present invention.

In the present invention, the controlling module 101 may be implemented by various types of electronic control units (ECUs), such as “vehicular computer” or “computer in vehicle” etc. Those ECUs may be generically defined as vehicular microcomputers or vehicular single chips, which are of the same functions as a general single chip integrated with large scaled integrated circuits (e.g. CPU), memory (e.g. ROM, RAM), I/O, A/D, shaping circuits and/or driving circuits, etc. In one embodiment, the controlling unit 101 may be a dedicated ECU, or it may be embedded with the ECU particularly designated for controlling the door locks (i.e. the door-lock-control ECU). Alternatively, the function of the controlling unit 101 may be added to the ECU designed for collecting information. The ECU communicates with the door-lock-control ECU or a BCM (Body Control Module) through buses. The various types of ECUs mentioned above may constitute a controller-area network (CAN) communicating through, for example, buses.

As also shown in FIG. 1, the controlling apparatus 100 further includes a programmable damper module 105. In one embodiment, the programmable damper module 105 may be of a magnetic type or a mechanical type. For a magnetic type damper, the resistance increases upon the increase of the magnetic field caused by the increase of the electric current passing through the electromagnetic coil, vice versa. Thus, the resistance provided thereof can be adjusted through the control of electric current. On the other hand, for a mechanical type damper module, such as damping hinges or damping slide rails, its resistance is provided by the hydraulic pressure generated from fluid and pistons. It should be noted that the magnitude of the resistance provided by the programmable damper module 105 may be changed continuously or stage-by-stage. For instance, numbers of mechanical type dampers can be parallelly connected to achieve the purpose of having a multi-staged resistance.

In the preferred embodiment of the present invention, the programmable damper module 105 adjusts the resistance imposed on the vehicle doors based on the level of the warning flag (extreme/high/moderate/low, etc). For example, as mentioned and shown in FIG. 3, if it is determined that the object B will be entering into the Zone in 0-2 seconds, a warning flag with an extreme-danger level is issued. As such, the programmable damper module 105 adjusts the imposed resistance to its maximum, so that the passenger/driver who wants to get off the vehicle A may not be able to easily open the door. Additionally, if the time of entrance is calculated to be more than 6 seconds, the processing unit 104 would issue a low-danger level of warning flag. Accordingly, programmable damper module 105 adjusts the imposed resistance to trivial or zero.

Based on the design of multi-staged resistance corresponding to the warning flags in the present invention, the passengers who want to get off the vehicle A will feel various degrees of resistance while opening the doors. Apart from serving the purpose of slowing down the door's open, the existence of the multi-degree resistances can also urge the passenger/driver to pay more attentions to the surrounding objects, such as pedestrians and approaching cars, without the reminder from other passengers or additional unlock actions, thereby achieving the proactively safety opening mechanism. Moreover, the imposed resistance varies based on the actual situation to provide proper damping degrees corresponding to the warning flags, rather than merely one damping degree. Thus, in the absence of additional facilities or warnings, the controlling system 100 of the present invent can provide the safety in a more proactive and less interfering way, which is a novel and non-obvious invention feature and approach.

In the embodiment of the present invention, the controlling module 101 may, based on the level of the warning flag, command the programmable damper module 105 to adjust its resistance. Alternatively, the processing unit 104 may directly control the programmable damper module 105 to issue the warning flags without the presence of the controlling module 101.

The controlling apparatus 100 as shown in FIG. 1 may also include a door limiter 107 to support and provide an even much safer mechanism for controlling the vehicle doors. Assuming in a scenario where the passenger/driver of the vehicle A is too hurrying or distracted to perceive the resistance from the programmable damper module 105, the door may still be completely opened and dangerous accidents may still occur. The door limiter 107 is therefore provided to further avoid situations as such. The door limiter 107 may be of a mechanical type or an electronic type. For a mechanical type door limiter, such as a torsion rod spring limiter or pulling rod limiter etc., can provide multiple gears through different protrusions and depressions on the arm. It should be noted that the mechanical type door limiter may be integrated with the hinge of vehicle door or the programmable damper module 105. As for an electronic limiter module, its operation is identical to magnetic dampers, i.e. through magnetic resistances to limit the vehicle doors.

In the present invention, the door limiter 107 functions to limit the maximum angle that the vehicle doors can be opened. In other words, the door limiter 107 causes a vehicle door to be opened at various angles based on the levels of the warning flag (extreme/high/moderate/low, etc). For example, with reference to FIG. 3, if it is determined that the object B will be in the Zone in 0-2 seconds, a warning flag with an extreme-danger level will be issued and accordingly the door limiter 107 exercises to limit the maximum angle that the vehicle door can be opened at less than, for instance, 15 degrees. Moreover, if the time of entrance is more than 6 seconds, the processing unit 104 would issue a low-danger level of warning flag upon which the door limiter 107 barely restrains the open angle. In one embodiment of the present invention, the door limiter 107 is provided in addition to the programmable damper module 105 to supplement the safety purpose. It should be noted that in another embodiment the door limiter 107 may serve as the major safety facilitate. That is, instead of having different degrees of imposed resistances to control the opening of the vehicle doors, one may achieve the same object by merely controlling the maximum angle the vehicle doors can be opened through the limiter 107. Similarly, various opening angles can also be achieved based on the levels of the warning flag. The above-mentioned angles and time periods are provided for discussion purpose merely and shall not constitute any restrictions on the present invention in any aspect.

It is also important to note that, according to the present invention, each door of the vehicle A can be either separately or jointly controlled through the controlling apparatus 100. Specifically, in the case of separate control, different degrees of resistances may respectively be imposed on the vehicle doors depending on the statuses of the relevant moving objects. As shown in FIG. 3, assuming a passenger (not shown on the diagram) tries to open the rear-right door of the vehicle A and the object B is approaching in 0-2 seconds. Meanwhile, the driver (not shown on the diagram) is also getting off the vehicle A from the front-left door and the object D is getting close in 4-6 seconds. Under the scenario, the programmable damper module 105 imposes the maximum resistance to the rear-right door and/or the door limiter 107 restrains the open angle of the right-rear door to be less that, for instance, 15-degree. On the other hand, the programmable damper module 105 imposes a moderate-level resistance to the front-left door, while the limiter 107 moderately limits the maximum angle the front-left door can be open at, for example, 45-degree. Under the effect of the two modules, both the passenger and the driver will be alerted and cannot open the rear-right door so easily and carelessly. However, it should be noted that the driver may feel less stressful than the passenger though they both intend to open the doors.

As for the joint control case, the controlling apparatus 100 according to the present invention may choose the most severe degree of resistance and open angle and apply to all the vehicle doors. More precisely, based on the above example, despite it will take the object D more time to enter the Zone and therefore there should be more lenience to the driver, the controlling apparatus 100 yet may still apply the maximum resistance to the front-left door and/or allow the front-left door to be opened only at 15-degree. That is, the controlling apparatus 100 will treat the front-left door as if it is the rear-right door in the case of joint control.

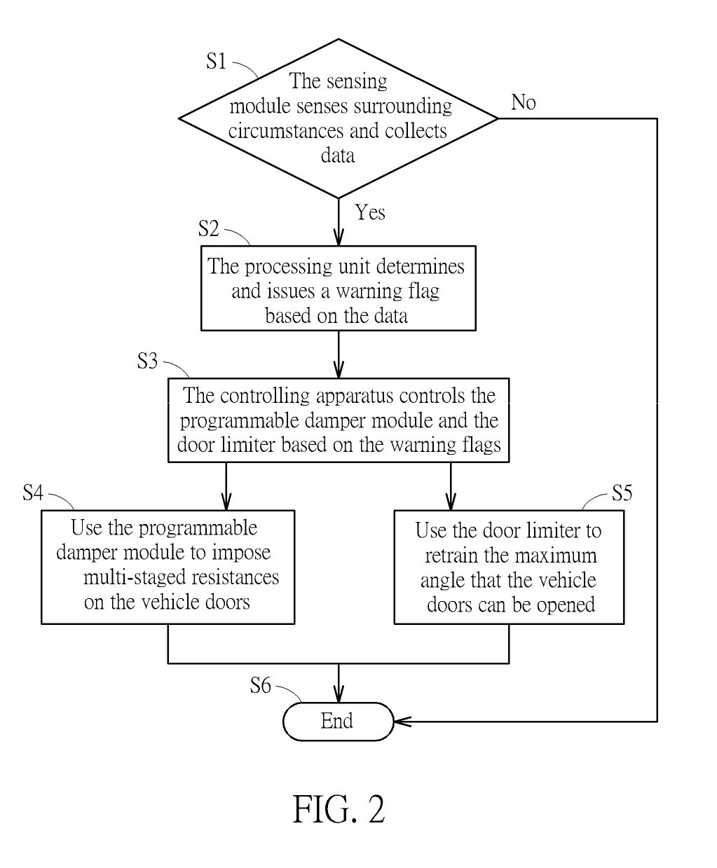

FIG. 2 illustrates a flowchart of a method for controlling the vehicle doors according to the present invention. Firstly, in step S1, the sensing module 103 automatically and continuously senses the surrounding circumstance of the vehicle A and collects data. The data therefore collected may include the distance between a moving object and the vehicle, a velocity and a moving direction of the moving object etc.

In step S2, the processing unit 104 analyzes the collected data to determine how much time it will take for the moving object to step into the Zone, and subsequently to decide whether to issue a warning flag. As mentioned, the Zone is defined as being equivalent to the width of the vehicle door plus a buffering distance. Similarly, the warning flag may be of different levels. If it is decided that the warning flag should be given, the processing unit 104 may further determine what level of the warning flag should be. Because the status of the moving object (e.g. approaching vehicles or pedestrians who are moving) is not constant, the level of the warning flag may also change from time to time.

Also shown in step S3 of FIG. 2, the controlling apparatus 100, upon receiving the warning flag and based on its level, controls the opening of the vehicle doors through either the programmable damper module 105, the door limiter 107, or the combination thereof. It should be noted that in the present invention, the programmable damper module 105 and the door limiter 107 may function all the time regardless whether the passenger/driver in the vehicle A is about to or when they will open the vehicle door. That means even when the vehicle A is parked aside, the programmable damper module 105 and the limiter 107 do not stop functioning and their operations will be subject to the surrounding circumstances.

If the control is through imposing resistances to the vehicle doors, as shown in step S4, the programmable damper module 105, based on the warning flag and probably its level, imposes a resistance on the vehicle doors. As a result, the passenger/driver will not be able to open the vehicle door easily. Moreover, the degree of resistance imposed on the vehicle door is adjustable based on the level of the warning flag, for example, imposing a specific damping strength on the connected doors. And, as disclosed, the applied resistance serves as an alerting signal to the passenger/driver as well.

On the contrary, if the open angle of door is concerned, as shown in step S5, the door limiter 107 is adopted to, based on the issued warning flag and probably the level, retrain the maximum angle that the vehicle doors can be opened. Moreover, the angle is also adjustable based on the level of the warning flag. Thus, even if the passenger/driver is careless and unaware of the approaching vehicles/pedestrians, the existence of limiter 107 will be able to reduce the occurrence of accidents.

Lastly, in step S6, the controlling apparatus 100 does not control the vehicle doors at all.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controlling apparatus that controls a vehicle door of a vehicle, comprising:
a sensing module configured to sense at least one object surrounding the vehicle and collect information related to the object;
a processing unit configured to receive and analyze information of the object and issue a warning flag based on a status of the object; and
a programmable damper module connected to the processing unit and configured to impose a resistance on the vehicle door and limit the vehicle door's open based on the warning flag.

2. The controlling apparatus that controls a vehicle door of a vehicle of claim 1, further comprising a controlling module connected to the processing unit and the programmable damper module, wherein the controlling module is configured to command the programmable damper module to impose the resistance on the vehicle door based on the warning flag.

3. The controlling apparatus that controls a vehicle door of a vehicle of claim 1, further comprising a door limiter connected to the processing unit and configured to restrain a maximum angle the vehicle door can be opened based on the warning flag.

4. The controlling apparatus that controls a vehicle door of a vehicle of claim 1, wherein the vehicle is provided with an open range equal to a width defined to the vehicle within which the vehicle door can be opened completely plus a buffering distance.

5. The controlling apparatus that controls a vehicle door of a vehicle of claim 4, wherein the warning flag is of a plurality of levels, and the processing unit determines the level of the warning flag based on a distance between the object and the vehicle, a velocity and a moving direction of the object, and a duration of time that the object will be entering into the open range.

6. The controlling apparatus that controls a vehicle door of a vehicle of claim 5, wherein the resistance provided by the programmable damper module is adjusted in accordance with the level of the warning flag.

7. The controlling apparatus that controls a vehicle door of a vehicle of claim 5, wherein the controlling apparatus further comprises a door limiter connected to the processing unit and configured to adjust a maximum angle that the vehicle door can be opened based on the level of the warning flag.

8. A controlling apparatus provided for a vehicle for controlling the opening of a vehicle door having an open range, comprising:
a sensing module arranged around the vehicle and configured to sense at least one moving object approaching the vehicle and collect information related to the moving object;
a processing unit connected to the sensing module and configured to analyze the information of the moving object and decide whether to issue a warning flag by determining whether the moving object will be entering into the open range and if so a time of the entrance; and
a controlling module connected to the processing unit and configured to control the opening of the vehicle door based on the warning flag.

9. The controlling apparatus provided for a vehicle for controlling the opening of a vehicle door having an open range of claim 8, wherein the open range is equal to a width defined to the vehicle within which the vehicle door can be opened completely plus a buffering distance.

10. The controlling apparatus provided for a vehicle for controlling the opening of a vehicle door having an open range of claim 9, wherein the information collected by the sensing module comprises a distance between the moving object and the vehicle, and a velocity and a moving direction of the moving object, wherein the processing unit calculates the time of entrance based on the distance, the velocity, and the moving direction, and the processing unit further decides whether to issue the warming flag based on the time of entrance.

11. The controlling apparatus provided for a vehicle for controlling the opening of a vehicle door having an open range of claim 8, wherein the warning flag is of a plurality of levels, and each of them represents the different duration of time that the moving object will be entering the open range.

12. The controlling apparatus provided for a vehicle for controlling the opening of a vehicle door having an open range of claim 11, further comprising a programmable damper module configured to impose a resistance on the vehicle door, wherein the imposed resistance is adjustable by the controlling module based on the level of the warning flag.

13. The controlling apparatus provided for a vehicle for controlling the opening of a vehicle door having an open range of claim 11, further comprising a door limiter configured to restrain a maximum angle that the vehicle door can be opened based on the level of the warning flag.

14. A controlling method provided for a vehicle door, comprising:
sensing at least one moving object approaching a vehicle;
collecting at least a distance between the moving object and the vehicle, and a velocity and a moving direction of the moving object;
analyzing the distance, the velocity and the moving direction to determine a duration of time that the moving object will be entering into an open range of the vehicle, and issue a warning flag accordingly; and
controlling the vehicle door based on the warning flag.

15. The controlling method provided for a vehicle door of claim 14, wherein the open range of the vehicle is a width defined to the vehicle within which the vehicle door can be opened completely plus a buffering distance.

16. The controlling method provided for a vehicle door of claim 14, further comprising imposing a resistance on the vehicle door to adjust a degree of difficulty for opening the vehicle door.

17. The controlling method provided for a vehicle door of claim 14, further comprising restricting a maximum angle that the vehicle door can be opened to adjust a degree the vehicle door can be opened.

18. The controlling method provided for a vehicle door of claim 14, further comprising leveling the warning flag into different degrees based on the duration of time that the moving object will be entering into the open range.

19. The controlling method provided for a vehicle door of claim 18, further comprising adjusting a resistance imposed to the vehicle door based on the level of the warning flag to adjust a degree of difficulty for opening the vehicle door.

20. The controlling method provided for a vehicle door of claim 18, further comprising adjusting a maximum angle that the vehicle door can be opened based on the level of the warning flag.
